(19) United States
(12) Patent Application Publication
(10) Pub. No.: US 2007/0077477 A1
(43) Pub. Date: Apr. 5, 2007

(54) Fuel cell unit

(75) Inventors: Satoshi Mogi, Kanagawa-ken (JP); Masaaki Shibata, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/581,612

(22) PCT Filed: Jan. 25, 2005
(86) PCT No.: PCT/JP05/01314

§ 371 Date: Jun. 5, 2006

(30) Foreign Application Priority Data
Jan. 27, 2004 (JP) 2004-018878

(51) Int. Cl. H01M 8/10; H01M 4/86; H01M 8/24; H01M 2/08

(52) U.S. Cl. 429/32; 429/44; 429/36

(57) ABSTRACT

A fuel cell unit is provided which comprises at least one structural member, the structural member comprising two electrolyte/electrode bonded members (14) each comprising a first electrode (13) and a second electrode (12) and an electrolyte membrane (11) disposed between the electrodes, a conductive porous substrate (15) disposed between the two electrolyte/electrode bonded members (14) so as to be in contact with the two first electrodes (13) of the two electrolyte/electrode bonded members, a conductive support member (18) provided on the porous substrate (15) so as to be electrically connected to the porous substrate (15) and the two first electrodes (13), and an electrical connection means (16) for electrically connecting the two second electrodes (12) being not in contact with the porous substrate of the electrolyte/electrode bonded members, and which attains size reduction, has as less wiring as possible, and gives a large electromotive force.

### TECHNICAL FIELD

The present invention relates to a fuel cell unit for generating an electric power by a reaction of a fuel with an oxidizer.

### BACKGROUND ART

In recent years, there have been high expectations placed on the application of fuel cells in small electronic devices such as digital cameras, notebook personal computers and other similar devices. This is because the amount of energy that a fuel cell can generate per unit volume thereof may be from several to nearly ten times that of a conventional battery, and because continuous use over a long period of time for such small electronic devices becomes possible by filling them with a fuel.

In a fuel cell, an electrolyte/electrode bonded member having an electrolyte membrane sandwiched by a fuel electrode comprising a catalyst and an oxidizer electrode comprising a catalyst is used as a power-generating portion. In this electrolyte/electrode bonded member, a fuel such as hydrogen gas is supplied to the fuel electrode side and an oxidizer such as oxygen gas is supplied to the oxidizer electrode side, whereby these reactants are caused to electrochemically react with each other via the electrolyte membrane.

As the electrolyte membrane for a fuel cell, while various types of membranes have been proposed, a membrane that employs a solid polymer is suitable especially for a portable small electronic device. The reason is that it has advantages of being able to be used at a temperature close to room temperature and to safely carry around because of the electrolyte membrane being not liquid but solid.

To drive a small electronic device, a stack configuration (fuel cell unit) is commonly used wherein a single fuel cell comprising an electrolyte/electrode bonded member is connected in plurality in series. This is because the electromotive force of an electrolyte/electrode bonded member is at most 1 V, which is small.

FIG. 8 is a schematic exploded view showing an example of a conventional fuel cell unit. The fuel cell unit has electrolyte/electrode bonded members 84 each having a fuel electrode 82 and an oxidizer electrode 83 provided on either side of an electrolyte membrane 81, which are stacked and connected in series via electrically conductive separators 85 such that the fuel electrode 82 and the oxidizer electrode 83 face each other. Further, an oxidizer flow path 86 for supplying an oxidizer to an adjacent oxidizer electrode and a fuel flow path 87 for supplying a fuel to an adjacent fuel electrode are respectively formed on each separator.

However, for a fuel cell unit having the above-described conventional stack structure, there is a problem that because the size is determined predominantly by the thickness of the separator, the fuel cell unit is large in the stack direction. To resolve this problem, there have been proposals for size reduction of a fuel cell unit (see, for example, Japanese Patent Application Laid-Open Nos. H9-45355 and 2000-058100).

In fuel cell units in accordance with these proposals, as shown in FIG. 9, electrolyte/electrode bonded members 84 are stacked such that fuel electrodes 82 themselves or oxidizer electrodes 83 themselves face each other via a support member 88 having an oxidizer flow path 86 or a fuel flow path 87 formed therein, thus reducing the size in the stack direction.

Japanese Patent Application Laid-Open No. H09-45355 mentioned above discloses a fuel cell unit in which a support member is constituted of an electrically conductive material and electrolyte/electrode bonded members are connected in parallel.

However, there is a problem for this fuel cell unit that because it is difficult to connect the electrolyte/electrode bonded members in series, an electromotive force sufficient to drive a small electronic device cannot be obtained.

On the other hand, Japanese Patent Application Laid-Open No. 2000-058100 above discloses a fuel cell unit in which a support is constituted of an insulating material and electrolyte/electrode bonded members are connected in series by wiring. Although in this fuel cell unit a sufficient electromotive force can be obtained, a space is additionally required to carry out the wiring, which is a factor that limits the size reduction.

The present invention has been accomplished in view of the above-mentioned problems, and it is, therefore, an object of the present invention to provide a fuel cell unit that attains size reduction, has as less wiring as possible, and gives a large electromotive force.

### DISCLOSURE OF THE INVENTION

That is, the present invention is a fuel cell unit comprising at least one structural member, the structural member comprising two electrolyte/electrode bonded members each comprising a first electrode and a second electrode and an electrolyte membrane disposed between the electrodes, a conductive porous substrate disposed between the two electrolyte/electrode bonded members so as to be in contact with the two first electrodes of the two electrolyte/electrode bonded members, a conductive support member provided on the porous substrate so as to be electrically connected to the porous substrate and the two first electrodes, and an electrical connection means for electrically connecting the two second electrodes, which are not in contact with the porous substrate, of the electrolyte/electrode bonded members.

The conductive support member is characterized by being electrically connected to the porous substrate and the two first electrodes through an opening part provided penetrating one electrolyte/electrode bonded member.

The electrical connection means is characterized by electrically connecting the two second electrodes of the two electrolyte/electrode bonded members via an insulating material that covers side surfaces of the porous substrate and the two electrolyte/electrode bonded members.

The electrical connection means is characterized by comprising a second electrode of two electrolyte/electrode bonded members formed by covering a side surface of a porous substrate with a continuous electrolyte/electrode bonded member.

The present invention is also characterized in that an insulating support member is disposed on the electrolyte/electrode bonded member.

The present invention is also characterized in that a sealing material is disposed on the electrolyte/electrode bonded member.

Furthermore, the fuel cell unit in accordance with the present invention comprises a stack of at least two of the above-mentioned structural members, wherein the second electrode of the electrolyte/electrode bonded member of a first structural member and the second electrode of the electrolyte/electrode bonded member of an adjacent second structural member are stacked so as to face (or be in opposition to) each other via an insulating sealing material, and the conductive support member connected to the first electrode of the electrolyte/electrode bonded member of the first structural member and the second electrode of the electrolyte/electrode bonded member of the adjacent second structural member are electrically connected, whereby the electrolyte/electrode bonded members of the first structural member and the adjacent second structural member are connected in series.

Moreover, the fuel cell unit in accordance with the present invention comprises a stack of a first stacked member and a second stacked member each comprising a stack of at least two of the above-mentioned structural members, wherein the first and the second stacked members each has a constitution such that the second electrodes of the electrolyte/electrode bonded members of adjacent structural members are disposed so as to face each other via an insulating sealing material, the conductive support member connected to the first electrode of the electrolyte/electrode bonded member of one of the adjacent structural members and the second electrode of the electrolyte/electrode bonded member of the other of the adjacent structural members are electrically connected, and the conductive support member of the structural member positioned at an end of the stacked member has a portion exposed outside of the stacked member, and wherein the exposed portions of the conductive support members of the first and the second stacked members are electrically connected to form the stack of the first and the second stacked members.

In addition, the fuel cell unit in accordance with the present invention comprises a stack of a first stacked member and a second stacked member each comprising a stack of two of the above-mentioned structural members, wherein the first and the second stacked members each has a constitution such that the second electrode of the electrolyte/electrode bonded member of the first structural member and the second electrode of the electrolyte/electrode bonded member of the adjacent second structural member are disposed so as to face each other via an insulating sealing material, the conductive support member connected to the first electrode of the electrolyte/electrode bonded member of the first structural member and the second electrode of the electrolyte/electrode bonded member of the adjacent second structural member are electrically connected, and the conductive support member of the adjacent second structural member has a portion exposed outside of the stacked member, and wherein the exposed portions of the conductive support members of the first and the second stacked members are electrically connected to form the stack of the first and the second stacked members.

The fuel cell unit in accordance with the present invention is formed by stacking structural members each comprising an electrolyte/electrode bonded member and a porous substrate, which can constitute a stack having a small size in the stack direction and a high generated energy density, and furthermore can give a large electromotive force with as less wiring as possible. For this reason, it is possible to produce a fuel cell unit in a simple process at a low cost.

Other features and advantages of the present invention will be apparent from the following description taken in conjunction with the accompanying drawings.

### BRIEF DESCRIPTION OF THE DRAWINGS

FIG. 1 is a schematic exploded perspective view showing one embodiment of the fuel cell unit in accordance with the present invention;

FIG. 2 is a schematic perspective view showing a structural member of the fuel cell unit shown in FIG. 1;

FIGS. 3A and 3B are schematic enlarged sectional views each showing an electrical connection means provided on a side surface of a structural member of the fuel cell unit in accordance with the present invention;

FIG. 4 is a schematic perspective view showing one example of the structural member of the fuel cell unit in accordance with the present invention;

FIG. 5 is a schematic perspective view showing another example of the structural member of the fuel cell unit in accordance with the present invention;

FIG. 6 is a schematic perspective view showing still another example of the structural member of the fuel cell unit in accordance with the present invention;

FIG. 7 is a schematic exploded perspective view showing another embodiment of the fuel cell unit in accordance with the present invention;

FIG. 8 is a schematic exploded perspective view showing one example of a conventional fuel cell unit; and

FIG. 9 is a schematic exploded perspective view showing another example of a conventional fuel cell unit.

### BEST MODE FOR CARRYING OUT THE INVENTION

The present invention will now be explained in detail.

The fuel cell unit in accordance with the present invention is a fuel cell unit comprising a structural member comprising an electrolyte/electrode bonded member, which comprises a first electrode disposed on first and second principal surfaces of a conductive porous substrate so as to be in contact with the first and second principal surfaces, an electrolyte membrane disposed in contact with the first electrode, and a second electrode disposed in contact with the electrolyte membrane, wherein the structural member comprises an opening part which penetrates the electrolyte/electrode bonded member on the first principal surface, a conductive support member which is electrically connected to the porous substrate and the first electrode through the opening part and which is not electrically connected to the second electrode, and an electrical connection means for electrically connecting the second electrodes of the electrolyte/electrode bonded member, which is formed on a part of a side surface of the porous substrate so as to be in contact with the first and second principal surfaces, and which is not electrically connected to the porous substrate and the first electrode.

The above-mentioned electrical connection means is characterized in that the part of the side surface of the porous substrate and a part of each of the electrolyte/electrode bonded members formed in contact with the first and second principal surfaces are covered with an insulating material, and that the insulating material, a part of the second electrode of the electrolyte/electrode bonded member formed in contact with the first principal surface, and a part of the second electrode of the electrolyte/electrode bonded member formed in contact with the second principal surface are covered with a conductive material.

The electrical connection means is also characterized in that the part of the side surface and the first and second principal surfaces of the porous substrate are covered with a continuous electrolyte/electrode bonded member.

Further, the present invention is characterized in that an insulating support member is disposed on the electrolyte/electrode bonded member.

Moreover, the present invention is characterized in that a sealing member is disposed on the electrolyte/electrode bonded member.

In addition, the fuel cell unit in accordance with the present invention is a fuel cell unit comprising a stacked member of at least two of the above-mentioned structural members, characterized in that a first principal surface of any one of the structural members constituting the stack and a second principal surface of adjacent one of the structural members are disposed so as to face each other, a second electrode of an electrolyte/electrode bonded member on the second principal surface side of the adjacent structural member is electrically connected to a conductive support member on the first principal surface side and is not electrically connected to a second electrode of the electrolyte/electrode bonded member on the first principal surface side.

Further, the fuel cell unit in accordance with the present invention is a fuel cell unit comprising a stack of two of the above-mentioned stacked members, characterized in that first principal surfaces positioned at an end of the stacked members are disposed so as to face each other, conductive support members of the first principal surfaces of the stacked members are electrically connected, and second electrodes of electrolyte/electrode bonded members of the first principal surface side of the stacked members are not electrically connected.

According to the fuel cell unit of the present invention as described above, size reduction is possible, while at the same time wiring can be reduced as far as possible and a large electromotive force can be obtained. For this reason, a low-cost-manufacturable fuel cell unit having a high energy density can be provided.

Embodiments in accordance with the present invention will now be described with reference to the drawings.

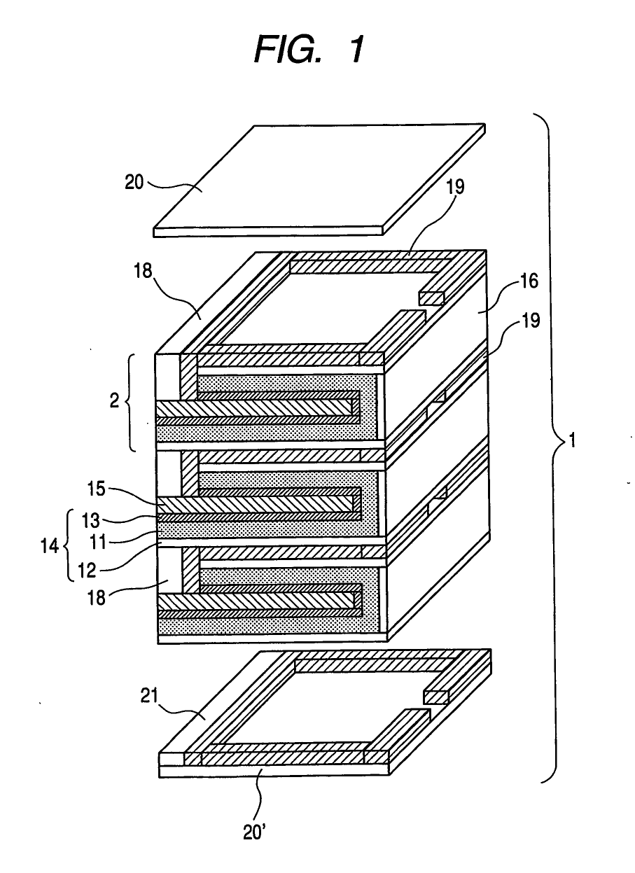

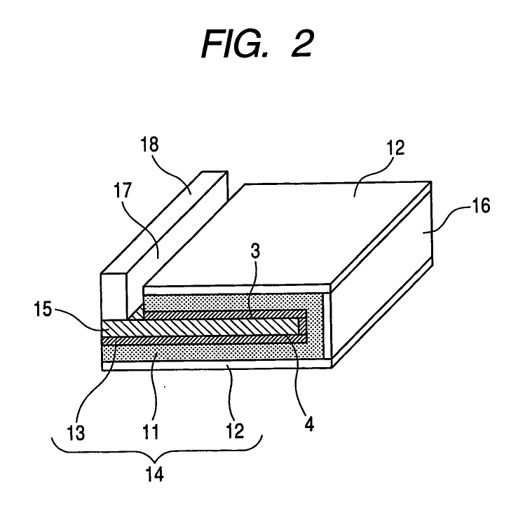

FIG. 1 is a schematic exploded perspective view illustrating one embodiment of the fuel cell unit in accordance with the present invention. FIG. 2 is a schematic perspective view illustrating one structural member of the fuel cell unit illustrated in FIG. 1.

As shown in FIG. 1, a fuel cell unit 1 in accordance with the present invention has a structure in which a plurality of structural members 2 are stacked. The structural members 2 have the same configuration, wherein as shown in FIG. 2, an electrolyte/electrode bonded member 14 is provided on both sides of and in contact with a plate-shaped conductive porous substrate 15. Further, there is provided on a side of a side surface of the plate-shaped conductive porous substrate 15 an electrical connection means 16 for electrically connecting electrodes 12 of the electrolyte/electrode bonded member that are not in contact with the porous substrate 15. An opening part 17 is provided at a portion of the electrolyte/electrode bonded member, and in the opening part a conductive support member 18 is disposed in electrical connection to the porous substrate.

Examples of the material for the porous substrate 15 include a conductive porous material such as foam metal or carbon, and a material prepared by making conductive a surface of an insulating porous material such as ceramic. The conductive porous substrate formed in the plate shape is provided in contact with the electrolyte/electrode bonded member 14 on opposing principal surfaces 3, 4 thereof. Thus, the electrolyte/electrode bonded member is supported by the porous substrate and a fuel or oxidizer is supplied thereto through the porous substrate. Further, the porous substrate also acts as an electrode for taking out an energy generated in the electrolyte/electrode bonded member.

The electrolyte/electrode bonded member 14 has a structure in which electrodes 12, 13 each containing a catalyst are disposed on both sides of a electrolyte membrane 11. Examples of the material used as the electrolyte membrane include a proton conductive polymer, specifically an ion-exchange membrane such as a perfluorocarbon type, a non-fluoro type or a hybrid type. However, the present invention is not particularly limited to these materials. Examples of electrodes containing a catalyst include a material consisting of a carbon powder that contains fine particles of platinum.

When a fuel is supplied to the electrolyte/electrode bonded member 14 through the porous substrate 15, the electrode 13 of the electrolyte/electrode bonded member 14 which is in contact with the porous substrate 15 serves as a fuel electrode (negative electrode) and the electrode 12 provided on a side of the electrolyte membrane 11 opposite to the porous substrate 15 side serves as an oxidizer electrode (positive electrode). On the other hand, when an oxidizer is supplied to the electrolyte/electrode bonded member 14 through the porous substrate 15, the electrode 13 of the electrolyte/electrode bonded member 14 which is in contact with the porous substrate 15 serves as an oxidizer electrode (positive electrode) and the electrode 12 provided on a side of the electrolyte membrane 11 opposite to the porous substrate 15 side serves as a fuel electrode (negative electrode).

Here, the electrode that is in contact with the porous substrate is termed “first electrode” and the electrode that is not in contact with the porous substrate is termed “second electrode”.

The electrical connection means 16 provided on a side of a side surface of the porous substrate 15 electrically connects oxidizer electrodes of the electrolyte/electrode bonded member disposed via the porous substrate when the porous substrate supplies a fuel and electrically connects fuel electrodes of the electrolyte/electrode bonded member disposed via the porous substrate when the porous substrate supplies an oxidizer.

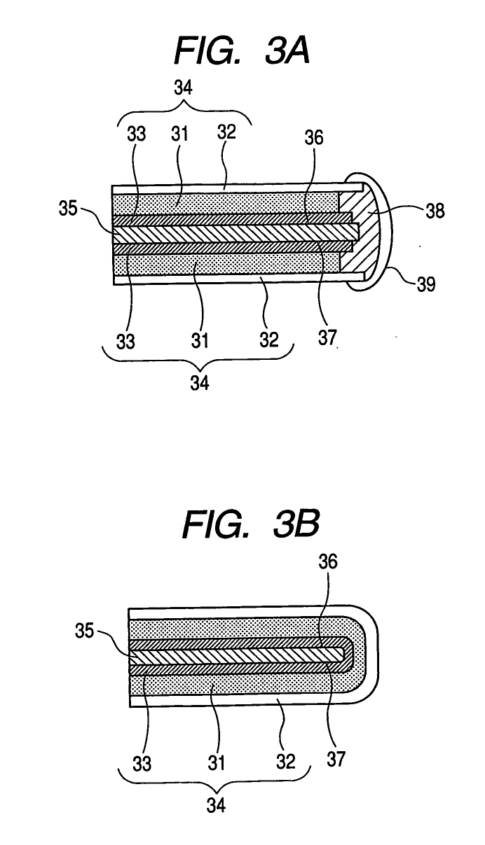

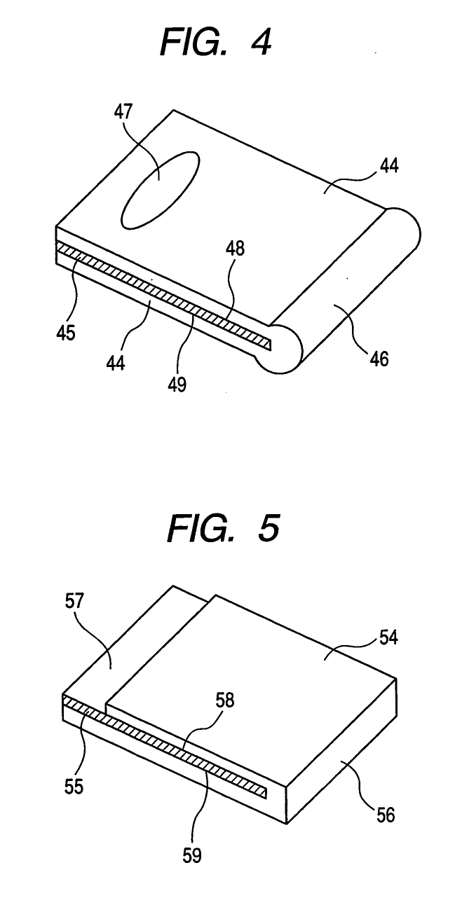

FIGS. 3A and 3B are schematic enlarged sectional views each illustrating an electrical connection means arranged on a side surface of a structural member of the fuel cell unit in accordance with the present invention. Electrical connection can be realized by, for example, providing electrolyte/electrode bonded members 34 on opposing principal surfaces 36, 37 of a porous substrate 35, then covering edges of the electrolyte/electrode bonded members 34 including a side surface of the porous substrate 35 with an insulating material 38, and electrically connecting the electrodes 32 using a conductive material 39 (FIG. 3A). Alternatively, it is also possible to fold back an electrolyte/electrode bonded member 34 at a side surface of a porous substrate 35 and pressure-bonding the folded member to opposing principal surfaces 36, 37 of the porous substrate 35 (FIG. 3B).

A portion of the electrolyte/electrode bonded member 14 provided on the opposing principal surfaces of the porous substrate 15 has an opening part 17. A conductive support member 18 provided in the opening part 17 of the electrolyte/electrode bonded member is electrically connected to the porous substrate 15. At this time, although the conductive support member 18 is electrically connected to the electrode 13 that is disposed in contact with the porous substrate 15, it is not electrically connected to the electrode 12 that is not in contact with the porous substrate 15.

Examples of the material for the conductive support member which can be used include a conductive material such as a metal or carbon, a material prepared by imparting conductivity to an insulating material such as plastic, and a conductive resin material or adhesive. It is preferable that a sealing material is applied to the opening part provided with a conductive material to thereby prevent leakage of a fuel or oxidizer.

A plurality of the structural members as configured above are stacked to form a stacked member. When stacking, the principal surface 3 of the porous substrate 15 provided with the conductive support member 18 of any one of the structural members and the principal surface 4 of the porous substrate 15 not provided with the conductive support member 18 of adjacent one of the structural members are disposed so as to face each other. Thus, the electrode 12 of the electrolyte/electrode bonded member 14 disposed on the principal surface 4 of the porous substrate 15 not provided with the conductive support member 18 of the one of the structural members is electrically connected to the conductive support member 18 of the adjacent one of the structural members, thereby forming a stacked member of the plurality of structural members that are connected in series.

In order to prevent electrical connection between the electrode 12 of the electrolyte/electrode bonded member 14 disposed on the principal surface 3 of the porous substrate 15 provided with the conductive support member 18 of the one of the structural members and the electrode 12 of the electrolyte/electrode bonded member 14 disposed on the principal surface 4 of the porous substrate 15 not provided with the conductive support member 18 of the adjacent one of the structural members, an insulating support member may be disposed between the electrodes. Further, it is also possible to form a fuel or oxidizer flow path between the electrodes by use of an insulating sealing member 19.

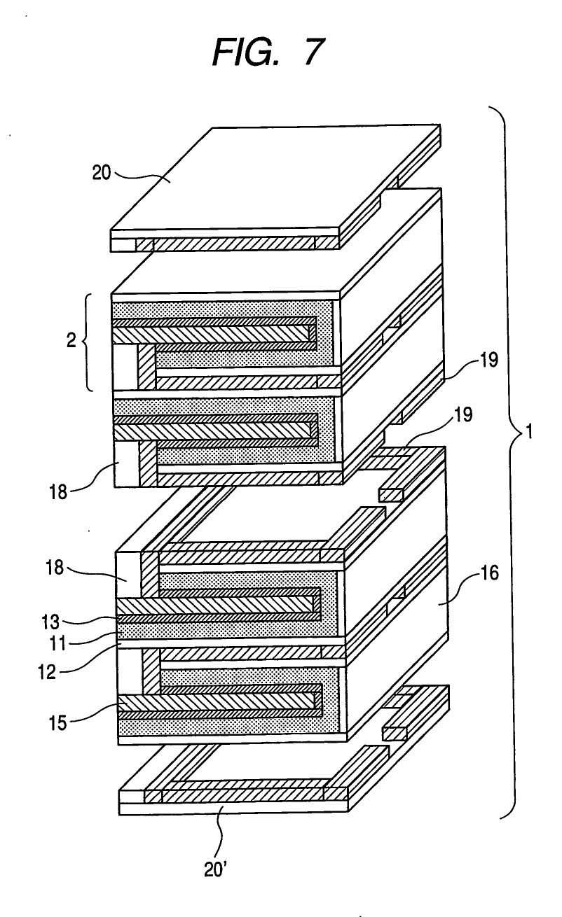

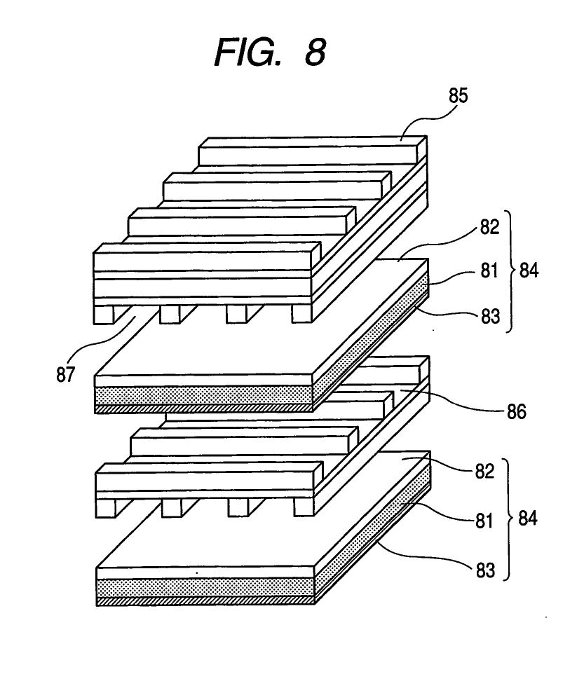

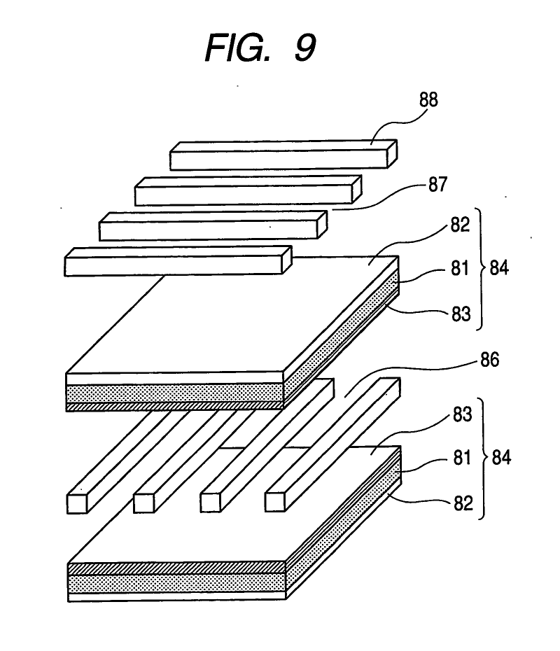

FIG. 7 is a schematic exploded perspective view illustrating another embodiment of the fuel cell unit in accordance with the present invention. As shown in FIG. 7, when two stacked members are arranged such that the principal surfaces 3 of the porous substrates 15 provided with the conductive support member 18 of the two stacked members face each other, it is possible to provide a configuration in which the stacked members are connected in parallel.

On the exterior of the structural members positioned at both ends of the stack, end plates 20, 20′ may further be provided to form a fuel flow path or an oxidizer flow path.

While FIG. 7 illustrates an example of stacking two stacked members each consisting of two structural members of a series arrangement, the present invention can be applied to a configuration of stacking stacked members each having more than two structural members arranged in series. Examples of such a configuration include a fuel cell unit comprising a stack of two stacked members each having three or four structural members arranged in series.

As described above, because the fuel cell unit in accordance with the present invention does not require a separator, it is possible to reduce the size in the stack direction. In addition, at the same time as stacking, wiring can be reduced as far as possible while allowing a large electromotive force to be achieved.

### EXAMPLES

The present invention will now be explained in further detail with reference to examples.

### Example 1

FIG. 4 is a schematic perspective view illustrating one example of the structural member of the fuel cell unit in accordance with the present invention.

As a conductive porous substrate 45, porous carbon was used. Electrolyte/electrode bonded members. 44 were prepared by using a Nafion film manufactured by DuPont as an electrolyte membrane and fixing to the surfaces of the film catalyst-carrying carbon particles having platinum as a catalyst metal dispersed in a fine particulate form on surfaces of carbon particles. The electrolyte/electrode bonded members 44 were pressure-bonded to the porous substrate 45 by hot pressing, whereby the electrolyte/electrode bonded members 44 were disposed in contact with both principal surfaces 48, 49 of the porous substrate 45.

A portion of the electrolyte/electrode bonded member 44 disposed on the principal surface 48 was cut out and removed, whereby an opening part 47 was provided in the electrolyte/electrode bonded member 44 so as to expose the porous carbon substrate 45. A conductive support member (not shown) made of carbon was bonded to the porous carbon substrate 45 in the opening part 47 using a conductive adhesive. An opening part formed between the conductive support member and the electrolyte/electrode bonded member was covered using a sealing material.

Next, as shown in FIG. 3A, a side surface of the porous substrate and a part of each of the electrolyte/electrode bonded members were covered with an insulating material 38, and then a conductive paste 39 was applied to form an electrical connection means 39 thereby electrically connecting the electrodes 32.

Thus, the electrolyte/electrode bonded members 44 were formed on the both surfaces of the porous substrate 45, wherein one of the electrolyte/electrode bonded members had the conductive support member in the opening part 47, thereby forming a structural member in which the electrodes in contact with the porous substrate were electrically connected via the porous substrate 45 and the electrodes being not in contact with the porous substrate were electrically connected by the electrical connection means 46.

### Example 2

FIG. 5 is a schematic perspective view illustrating another example of the structural member of the fuel cell unit in accordance with the present invention.

As a conductive porous substrate 55, a member having gold plated on a foamed metal made of stainless steel (SUS) was used. An electrolyte/electrode bonded member 54 was prepared by using a Nafion film manufactured by DuPont as an electrolyte membrane and fixing to surfaces of the film catalyst-carrying carbon particles having platinum as a catalyst metal dispersed in a fine particulate form on surfaces of carbon particles.

The porous substrate 55 had a side surface cut into a round shape at edge portions. As shown in FIG. 3B, on both principal surfaces 58, 59 (corresponding to 36, 37. In FIG. 3B) of the porous substrate, the electrolyte/electrode bonded member 54 was folded back at a side surface of the porous substrate and the folded-back member was pressure-bonded to the porous substrate, whereby the electrolyte/electrode bonded member 54 was disposed in contact with the porous substrate 55. The folded-back part of the electrolyte/electrode bonded member 54 formed an electrical connection means 56. At this time, a part of the principal surface 58 of the porous substrate 55 was not covered with the electrolyte/electrode bonded member 54 to provide an opening part 57.

At the opening part 57, a copper plate (not shown) was disposed in contact with the porous substrate to provide a conductive support member.

### Example 3

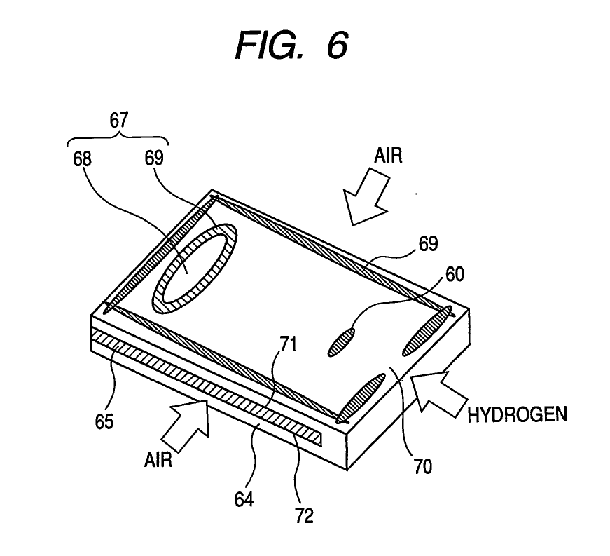

FIG. 6 is a schematic perspective view illustrating another example of the structural member of the fuel cell unit in accordance with the present invention.

In the present example, a porous substrate was used as an oxidizer flow path and was open to the atmosphere, while electrodes connected by electrical connection means were used as fuel electrodes and supplied with hydrogen.

In the structural member of the same structure as that prepared in Example 1 or 2, a sealing member 69 made of an elastomer was provided on a periphery of an electrolyte/electrode bonded member 64 provided on a principal surface 71 of a porous substrate 65 having a conductive support member 68 in an opening part 67. The sealing member 69 defined a fuel flow path, while a part not provided with the sealing member 69 defined a fuel supply port 70. Further, an insulating support member 60 made of plastic was also disposed on a part thereof. Incidentally, a gap formed between the electrolyte/electrode bonded member 64 and the conductive support member 68 was filled with the sealing member 69.

This structural member was stacked in plurality to form a fuel cell unit with a configuration similar to that shown in FIG. 1.

In this case, reference numeral 2 in FIG. 1 denotes the structural member shown in FIG. 6. In the present example, a stacked member consisting of three layers of the structural members 2. The respective structural members were disposed such that the principal surface 71 provided with the conductive support member 68 and a principal surface 72 of the adjacent structural member not provided with the conductive support member 68 faced each other. Contact between the opposing fuel electrodes provided via the fuel flow path could be prevented by the insulating support member 60.

Conductive end plates 20, 20′ were disposed at both ends of the stacked member. The end plate 20 was connected to the conductive support member 18 to function as a positive electrode, while the end plate 20′ was connected to the fuel electrode via a conductive member 21 provided separately to function as a negative electrode.

The structural member configured as described above, when stacked in plurality, could form a stacked member in which the respective structural members were connected in series, which could achieve a large electromotive force without wiring. In addition, a separator was not needed, whereby a fuel cell unit could be configured having a small size in the stack direction and a high generated energy density.

### Example 4

FIG. 7 is a schematic exploded perspective view illustrating a fourth example of the fuel cell unit in accordance with the present invention.

In the present example, four of the same structural members as those prepared in Example 3 were used. Two stacked members each having two layers of the structural members were formed following the same procedure as in Example 3. These two stacked members were disposed, as shown in FIG. 7, specifically such that their principal surfaces, on which a conductive support member was formed, face each other and the conductive support members were electrically connected. This connected conductive support members were used as a positive electrode, and the both end plates were connected by separate wiring to use them as negative electrodes, thereby forming a fuel cell unit.

Fuel flow paths were provided between the principal surfaces of adjacent structural members and between each of the end plates 20, 20′ and an adjacent structural member by use of a sealing material, and the porous substrates were made to be open to the atmosphere. In this way a fuel cell unit was configured in which two stacked members each having two structural members connected in series were connected in parallel.

The fuel cell unit configured as described above enabled stacking with as less wiring as possible and could be configured to have a high generated energy density per unit volume.

### INDUSTRIAL APPLICABILITY

The fuel cell unit in accordance with the present invention can be formed by stacking structural members each comprising electrolyte/electrode bonded members and a porous substrate, thereby providing a stacked member having a small size in the stack direction and a high generated energy density. In addition, because a large electromotive force can be achieved while reducing wiring as far as possible, the present fuel cell unit can be applied as a fuel cell unit used in a small electronic device such as a digital camera, a notebook personal computer and the like.

1. A fuel cell unit comprising at least one structural member, the structural member comprising two electrolyte/electrode bonded members each comprising a first electrode and a second electrode and an electrolyte membrane disposed between the electrodes, a conductive porous substrate disposed between the two electrolyte/electrode bonded members so as to be in contact with the two first electrodes of the two electrolyte/electrode bonded members, a conductive support member provided on the porous substrate so as to be electrically connected to the porous substrate and the two first electrodes, and an electrical connection means for electrically connecting the two second electrodes, which are not in contact with the porous substrate, of the electrolyte/electrode bonded members.

2. The fuel cell unit according to claim 1, wherein the conductive support member is electrically connected to the porous substrate and the two first electrodes through an opening part provided penetrating one electrolyte/electrode bonded member.

3. The fuel cell unit according to claim 1, wherein the electrical connection means electrically connects the two second electrodes of the two electrolyte/electrode bonded members via an insulating material that covers side surfaces of the porous substrate and the two electrolyte/electrode bonded members.

4. The fuel cell unit according to claim 1, wherein the electrical connection means comprises a second electrode of two electrolyte/electrode bonded members formed by covering a side surface of a porous substrate with a continuous electrolyte/electrode bonded member.

5. The fuel cell unit according to claim 1, wherein an insulating support member is disposed on the electrolyte/electrode bonded member.

6. The fuel cell unit according to claim 1, wherein a sealing material is disposed on the electrolyte/electrode bonded member.

7. The fuel cell unit according to claim 1, which comprises a stack of at least two of the structural members set forth in claim 1, wherein the second electrode of the electrolyte/electrode bonded member of a first structural member and the second electrode of the electrolyte/electrode bonded member of an adjacent second structural member are stacked so as to face each other via an insulating sealing material, and the conductive support member connected to the first electrode of the electrolyte/electrode bonded member of the first structural member and the second electrode of the electrolyte/electrode bonded member of the adjacent second structural member are electrically connected, whereby the electrolyte/electrode bonded members of the first structural member and the adjacent second structural member are connected in series.

8. The fuel cell unit according to claim 1, which comprises a stack of a first stacked member and a second stacked member each comprising a stack of at least two of the structural members set forth in claim 1, wherein the first and the second stacked members each has a constitution such that the second electrodes of the electrolyte/electrode bonded members of adjacent structural members are disposed so as to face each other via an insulating sealing material, the conductive support member connected to the first electrode of the electrolyte/electrode bonded member of one of the adjacent structural members and the second electrode of the electrolyte/electrode bonded member of the other of the adjacent structural members are electrically connected, and the conductive support member of the structural member positioned at an end of the stacked member has a portion exposed outside of the stacked member, and wherein the exposed portions of the conductive support members of the first and the second stacked members are electrically connected to form the stack of the first and the second stacked members.

9. The fuel cell unit according to claim 1, which comprises a stack of a first stacked member and a second stacked member each comprising a stack of two of the structural members set forth in claim 1, wherein the first and the second stacked members each has a constitution such that the second electrode of the electrolyte/electrode bonded member of the first structural member and the second electrode of the electrolyte/electrode bonded member of the adjacent second structural member are disposed so as to face each other via an insulating sealing material, the conductive support member connected to the first electrode of the electrolyte/electrode bonded member of the first structural member and the second electrode of the electrolyte/electrode bonded member of the adjacent second structural member are electrically connected, and the conductive support member of the adjacent second structural member has a portion exposed outside of the stacked member, and wherein the exposed portions of the conductive support members of the first and the second stacked members are electrically connected to form the stack of the first and the second stacked members.
